(19) United States
(12) Patent Application Publication
(10) Pub. No.: US 2008/0170678 A1
(43) Pub. Date: Jul. 17, 2008

(54) SIGNALLING METHOD TAKING ACCOUNT OF THE REASON FOR THE CALL

(75) Inventors: Pascal DAVOUST, Le Perreux Sur Marne (FR); Arnaud Vergnol, Beauchamp (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/972,425

(22) Filed: Jan. 10, 2008

(30) Foreign Application Priority Data
Jan. 11, 2007 (FR) 0752622

(51) Int. Cl. H04M 3/42

(52) U.S. Cl. 379/201.01

(57) ABSTRACT

Method of signalling a call from a sending equipment (2, 4) on receiving equipment (3, 4), this method comprising the following operations:

create a request to set up communication from the sending equipment (2, 4) addressed to the receiving equipment (3, 4);

include a subject message dealing with the reason for the call, within the request;

transmit the request to set up a communication containing the subject message, to the receiving equipment (3, 4);

the receiving equipment (3, 4) receives the request to set up a communication;

the receiving equipment (3, 4) accepts the subject message (3, 4).

The invention relates to the domain of telecommunications. It is most specifically related to putting two items of equipment into contact, namely calling equipment and called equipment.

Classically, a telephone communication comprises a phase before the communication itself, in which the communication is set up. During this prior phase, also called the signalling phase, the call from the calling equipment is presented to the called equipment by means of a warning that may be audible (for example a ring tone or music), visual (for example by displaying a light indicator) or mechanical (or example by vibration), or these three types can be combined.

Modern portable communicating equipment (cell phones, PDA (Personal Digital Assistant), pagers, etc.) comprise memories in which a certain amount of information is stored, for example personal information about the owner (name, first name, address, function, etc.). They also comprise interfaces through which they display information about the calling terminal (call number, name and possibly photograph of the caller, etc.) when a call is presented. Due to these features, as soon as the call is presented, users can choose whatever action they consider to be most appropriate, take or refuse the call, forward to a telephone exchange or a voice mailbox, put on hold, etc. Telecommunication servers provided with call management functions, particularly send, reception, rejection, put on hold and forward, can also be included in the communicating equipment.

It is now standard practice to automatically display the calling equipment number on a graphic interface of the called equipment. Most communicating equipment can even be personalized to generate a different ring tone or music depending on the assumed identity of the caller.

American patent U.S. Pat. No. 6,950,504 contains illustrations of these techniques.

Considering user habits developed through features available on portable communicating equipment, there is a need to transpose these functions to fixed telephony, and particularly to business phones. This transposition is now possible through telephony networks using the IP protocol (technology usually referred to as VoIP (Voice over Internet Protocol)). VoIP networks use appropriate telephones called IP phones that convert the analogue signal carrying voice into a digital signal, and create IP packets from this digital signal that are then put into a frame and transmitted on the network (usually using the Ethernet protocol).

The signalling phase in VoIP networks is usually done using the SIP (Session Initiation Protocol) described in standard RFC3261 published in June 2002.

One line of progress with VoIP networks is that they enable telephony to be integrated into data processing, with all the resulting advantages (single network, possibility of conventional software applications using voice files (save, compression, encryption, etc.)).

However despite the progress made, VoIP network features are not sufficient to enable reasoned call management. In particular, in practice it is found that people often accept communications even when they consider them unwanted, either in terms of communication content, or date or time.

In particular, the invention is intended to facilitate call management by disclosing a method of signalling a call from calling equipment on called equipment, this method comprising the following operations:

reception of a request to set up communication from the calling equipment sent to the called equipment;

detection of a message dealing with the reason for the call, within the request;

transmission of the request to set up a communication containing the subject message, to the called terminal;

the called terminal displays the subject message;

and characterised in that it also consists of adding at least one proposed answer into said request, before sending it to the receiving equipment.

According to one preferred embodiment, it consists of determining at least one proposed answer in an intermediate server based on information available to it in real time, so that it can add at least one proposed answer to said request before transmitting it to the receiving equipment.

Advanced knowledge of the subject of the call and a proposed answer adapted to the context of the communication makes it easier for the called party to manage his calls, by allowing him to choose the action to take when he receives a request to set up a communication (answer, refuse to accept the call, send an answer in text format, forward the call, etc.), in full knowledge of the facts.

The subject message can be presented on the called equipment by displaying it on a graphic interface or by playing it on a sound interface, in which case the subject message in a text format is converted into a voice message that can be played on this sound interface, before the request to set up a communication is sent to the called equipment.

The following additional operations may also be included:

the called terminal edits an answer message (for example chosen among a set of predetermined messages stored in memory) to the subject message;

transmission of the response message to the calling terminal.

According to one embodiment, the request from the calling terminal is an SIP request.

Other purposes and advantages of the invention will become clear after reading the following description made with reference to the appended drawings, in which:

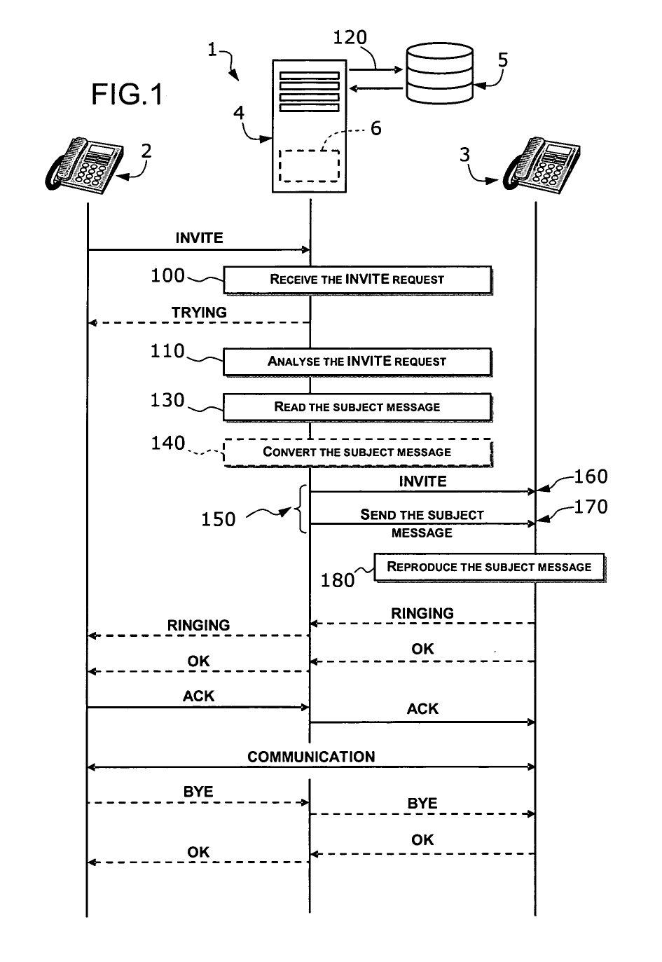

FIG. 1 is a diagram showing communication operations between two terminals within a telecommunications network;

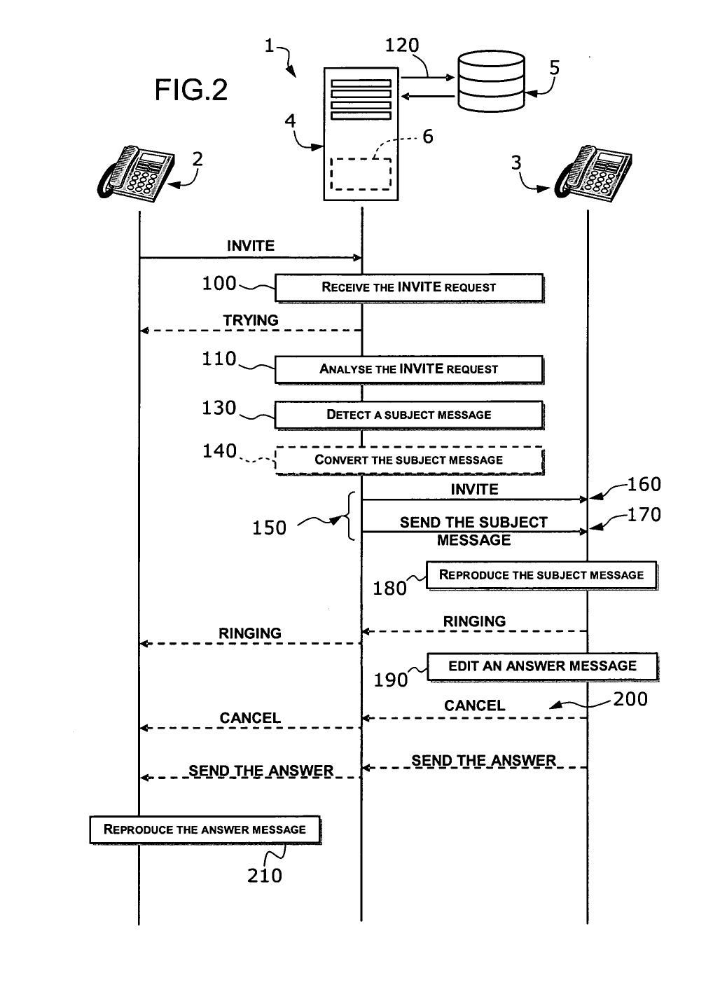

FIG. 2 is a diagram similar to FIG. 1, showing a variant embodiment;

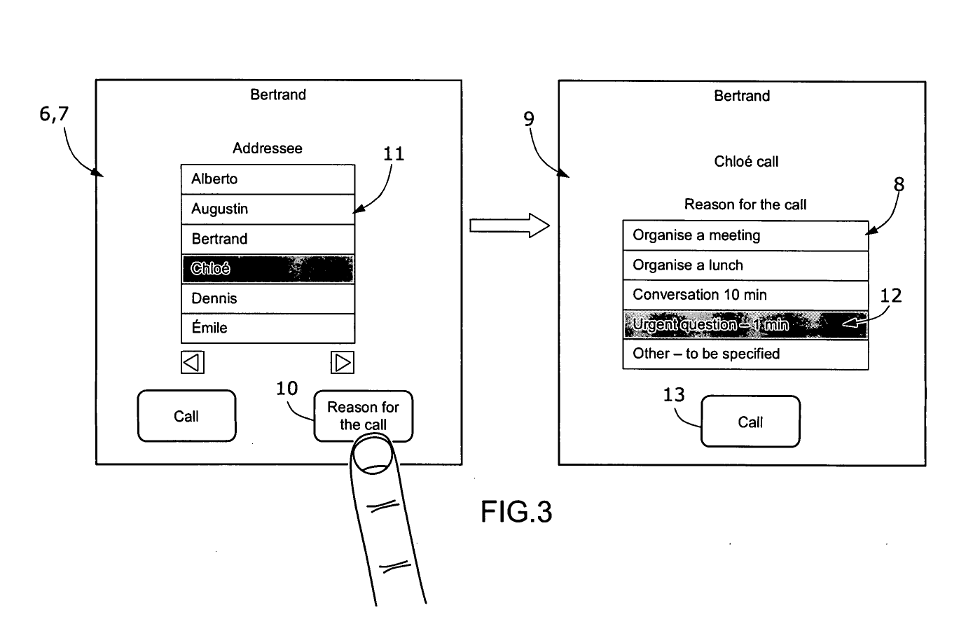

FIG. 3 is a diagrammatic view of a graphic interface on a calling terminal; and

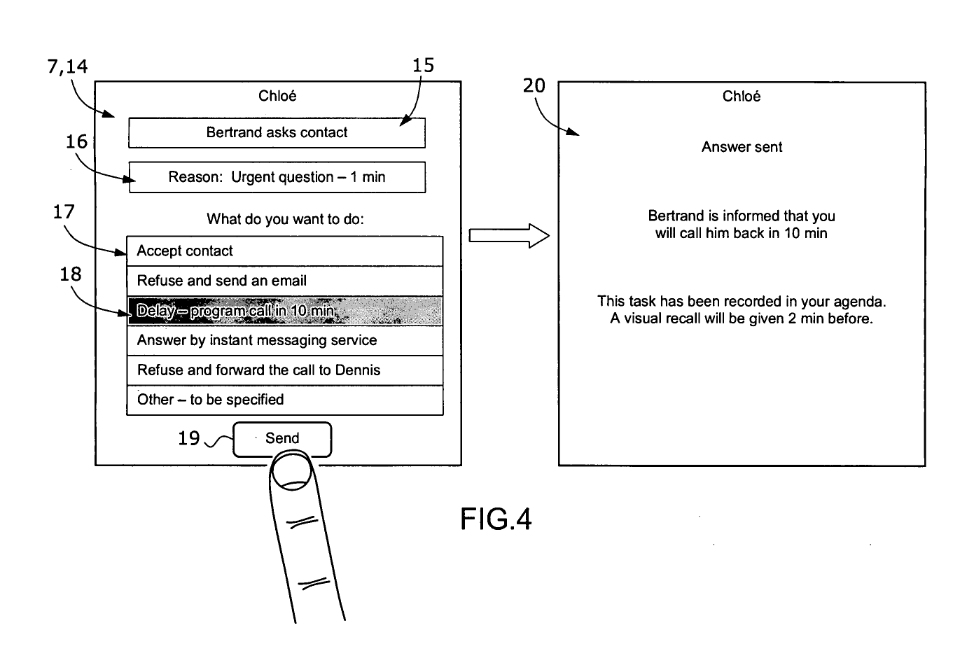

FIG. 4 is a diagrammatic view of a graphic interface on a called terminal.

FIGS. 1 and 2 show a VoIP type of telecommunication network 1 comprising several items of communicating equipment, namely two terminals 2, 3 in the form of IP telephones, and a mandatory server 4 (proxy).

It is considered that the proxy server 4 and one of the terminals (for example the terminal 3) form part of the same LAN (Local Area Network). In this case, the proxy server 4 is preferably connected to a database 5 in which associations between URI (Uniform Resource Identifier) and IP (Internet Protocol) addresses of all terminals 3 in the LAN network are stored.

The server 4 and the terminals 2, 3 are all designed to send and receive calls. According to a conventional scheme, the server 4 is used as a telecommunication relay during a communication to be set up between the two terminals 2, 3. At least two other schemes could be envisaged. According to a first alternate scheme, the server 4 receives a call from a sending terminal (for example the terminal 2 outside the LAN network) without transferring it to another terminal; in this case, the server 4 is considered to be the receiver of the call. According to a second alternate scheme, the server 4 sends a call to a receiving terminal (for example to the terminal 3 internal to the LAN network) or forwards it after receiving it and modifying it, for example by adding information. In this case, the server 4 is considered to be the sender of the call.

The example described below is an example according to the conventional scheme; it is assumed that the terminal 2 (outside the LAN network) is the sending equipment, while the second terminal 3 is the receiving equipment.

Although the invention is not limited to this technology, in this case the network 1 is configured to use the SIP protocol when setting up and terminating communications. To achieve this, the equipment (terminals 2, 3 and the server 4) each comprise a software application called the UA (User Agent) implemented on the processor and programmed to generate SIP requests. The UAs of the sending equipment (in fact terminal 2) and the receiving equipment (in fact terminal 3) are called UAC (User Agent Client) and UAS (User Agent Server) respectively.

When the sending terminal 2 sends a call to the receiving terminal 3, the UAC creates a SIP request to set up a communication (INVITE) in the form of a sequence of text lines, namely:

a first line called the start line containing a text message including the term INVITE followed by the URI address of the called terminal, and

one or several so-called header lines, each of which contains a text message containing a predefined header followed by a value.

The headers comprise at least the URI address of the calling terminal 2 (From) and the Subject. The following shows an example of this type of SIP request:

INVITE sip : receiving terminal@lan.com

From: sending terminal@uac.com

Subject: Urgent question—1 min

As can be seen, the request to set up a communication includes a subject message that describes the reason for the call. In this example, this message is “Urgent question—1 min”.

The subject message containing the reason for the call can either be input by the user of the sending terminal 2 using an alphanumeric keyboard, or it can be generated automatically by conversion of a voice message into a text message using a voice recognition (speech to text) application, or it can be chosen from among a list of messages previously memorized in the sending terminal.

The latter case in FIG. 3 shows an example in which the subject message can be chosen from a list displayed in the form of a pulldown menu 8 displayed on a secondary screen 9 of the interface 7 by activating an appropriate key 10 (in this case called “reason for call”), on a primary screen 6 displayed on a graphic interface 7 of the sending terminal 2. The key 10 may be a physical button in the terminal 2, in which case it is activated by pressing it, or it could be a delimited area in the primary screen 6, in which case it can be selected by using directional selection buttons, or if the interface 6 is touch sensitive (as shown in FIG. 3) by pressing on the area delimiting the key 10.

In the example shown, the sending terminal user (called Bertrand) wants to contact Chloé for an urgent question that will require a telephone conversation that will last one minute.

Bertrand selects Chloé among a set of addressees displayed on the primary screen 6 in a list in the form of a pulldown menu 11, and then presses the key 10 “Reason for call” to access the menu 8 and select the appropriate subject message 12; “Urgent question—1 min”. Bertrand then sends the call, for example by pressing a key 13 entitled “Call”. The request to set up the communication is then sent to Chloé.

The request passes through the server 4, that detects the presence of the subject message 12 and reads its contents, and may also add proposed replies into it (see below) before forwarding the request to the receiving terminal 3.

When it receives the request to set up a communication from the sending terminal 2, the receiving terminal 3 of the User Chloé displays a message 15 on a primary screen 14 of its interface 7, informing Chloé that a request to set up a communication has been received from Bertrand, as shown in FIG. 4. The interface 7 also displays a subject message 16 recalling the subject message 12 sent by the sending terminal 2.

Chloé can then choose the action that she wishes to take in reply to the request to set up a communication, by selecting it from among a list of predefined actions displayed on the terminal 3 in the form of a pulldown menu 17. These actions will have been memorised, for example partly in the terminal 3 itself and partly in the server 4 that, depending on the information available to it in real time (particularly transfer possibilities depending on the availability of other terminals to which it is connected), is capable of proposing additional actions to the user of terminal 3 as soon as the request to set up a communication is received, and these actions are added to the predefined actions already stored in it.

For example, the action entitled “Refuse and forward the call to Dennis” is proposed by the server 4, which is informed about the availability of the terminal corresponding to the user “Dennis”. The server sends this proposed action to the receiving terminal 3 at the same time as the request to set up a communication.

Therefore considering the example described above (case of a SIP request), the server 4 adds an answer to the request. Therefore the SIP request sent to the terminal 3 may use the following syntax:

INVITE sip: receiving terminal@lan.com

From: sending terminal@uac.com

Subject: Urgent question—1 min

Answer: Refuse and forward the call to Dennis

For example, assuming that Chloé does not want to take the call but decides to delay the call by programming a recall 10 minutes later. She would then select a message 18 entitled “Delay—program recall in 10 minutes” and press a key 19 entitled “Send” (for example in the example shown, it is a touch sensitive area in the interface 7 of the terminal 3).

Pressing the key 19 will cancel the request to set up a communication and make the receiving terminal 3 send the selected message to the sending terminal 2. The terminal 3 programs an automatic recall, with prior visual display (in fact two minutes before the automatic recall). According to one embodiment shown in FIG. 4, a summary of each action undertaken is displayed on a secondary screen 20 on the interface 7 of the terminal 3.

We will now describe a signalling method used to perform the operations presented in the above example, with reference to FIGS. 1 and 2.

A first operation 100 is reception by the server 4 of the INVITE message to set up a communication built up and then sent by the sending terminal 2, to the receiving terminal 3.

A second operation 110 is the analysis of the INVITE message by the server 4. A third operation 120 is to query the database 5 to identify the receiving terminal 3.

A fourth operation 130 is detection and reading of the subject message contained in the INVITE request, by the server 4.

A fifth optional operation 140 is conversion of the subject message from text to a voice message (text to speech), assuming that the receiving terminal 3 has no display function by which it can display the text of the subject message. The database 5 is notified about the features of terminals connected to the server 4 to enable this action.

A sixth operation 150 is transmission of the INVITE request with the subject message, by the server 4 to the receiving terminal 3.

A seventh operation 160 is reception of the request to set up a communication, by the receiving terminal 3. An eighth operation 170 is the receiving terminal 3 accepting the subject message, followed by a ninth operation 180 being the reception terminal 3 reproducing the subject message, either in text on a graphic interface, or in voice on a sound interface (such as a loudspeaker), depending on the features of the receiving terminal 3.

Having become aware of the subject message, the user of the receiving terminal 3 can accept the communication and therefore give a positive reply to the request to set up a communication. The following operations may then consist simply of lifting the handset of the receiving terminal 3, putting terminals 2 and 3 into communication, and then termination of the communication, as shown in FIG. 1.

As a variant, and as suggested in the example described above, the user of the receiving terminal 3 might not want to accept a communication with the user of the sending terminal 2 (or at least not immediately).

Consequently, an eighth operation 190 consists of displaying an answer message on the receiving terminal 3, a ninth operation being to cancel the request to set up a communication and transmission of an answer message to the sending terminal 2. The tenth and final operation 210 consists of reproducing the answer message on the interface of the sending terminal 2 in text form or in voice form (after conversion), as illustrated in FIG. 2.

Note that although the example presented above refers to telephony on IP, the invention can also be applied to other communication modes and to other types of equipment, such as communicating PDAs, also called “smartphones”.

The method described above has the advantage of making communications more precise and more efficient, since they are not started until the two parties (sending and receiving) are ready to communicate and both know the subject of the communication.

Knowledge about the reason for the call enables the receiving party to manage his calls better by accepting some communications considered for example to be important or urgent, while refusing or postponing others.

1. Method of signalling a call from a sending equipment (2) on receiving equipment (3), this method comprising the following operations:
create a request to set up communication from the sending equipment (2) addressed to the receiving equipment (3);
include a subject message dealing with the reason for the call, within the request;
transmit the request to set up a communication containing the subject message, to the receiving equipment (3);
the receiving equipment (3) receives the request to set up a communication;
the receiving equipment (3) reproduces the subject message;
and being characterised in that it also consists of adding (150) at least one proposed answer into said request, before sending it to the receiving equipment (3).

2. Signalling method according to claim 1, characterised in that it consists of determining at least one proposed answer in an intermediate server (4) based on information available to it in real time, so that it can add (150) at least one proposed answer to said request before transmitting it to the receiving equipment (3).

3. Signalling method according to claim 2, in which the subject message is reproduced by the receiving equipment (3) by displaying it on a graphic interface (7).

4. Signalling method according to claim 2, in which the subject message is reproduced by the receiving equipment (3) by playing it on a sound interface (7).

5. Signalling method according to claim 4, in which an operation is performed to convert the subject message into a message that can be played on the sound interface of the receiving equipment (3), before the request to set up a communication is sent to the receiving equipment (3).

6. Signalling method according to claim 1, which includes the following additional operations:
the receiving equipment (3, 4) edits (190) an answer message to the subject message, this answer message being selected from at least one proposed message added to said request;
the receiving equipment (3) transmits (200) the response message to the sending equipment (2).

7. Signalling method according to claim 6, in which the answer message is chosen from a set of predetermined messages stored in memory.

8. Signalling method according to claim 1, in which the request from the sending equipment (2) is a SIP request.

9. Telecommunication server, characterised in that it comprises means of implementing the method according claim 1.
